(19) United States
(12) Patent Application Publication
(10) Pub. No.: US 2026/0065810 A1
(43) Pub. Date: Mar. 5, 2026

(54) LABEL AND LABEL MANUFACTURING METHOD

(71) Applicant: FUJI SEAL INTERNATIONAL, INC., Osaka-shi, Osaka (JP)

(72) Inventors: Madoka MITANI, Osaka-shi, Osaka (JP); Masafumi HARADA, Osaka-shi, Osaka (JP)

(73) Assignee: FUJI SEAL INTERNATIONAL, INC., Osaka-shi, Osaka (JP)

(21) Appl. No.: 19/105,868

(22) PCT Filed: Jul. 21, 2023
(86) PCT No.: PCT/JP2023/026713

§ 371 Date: Feb. 24, 2025

(30) Foreign Application Priority Data
Sep. 20, 2022 (JP) 2022-149110

(51) Int. Cl. G09F 3/02

(52) U.S. Cl. CPC G09F 3/02; G09F 2003/0202; G09F 2003/0208

(57) ABSTRACT

A label includes a first printed base layer which is a water-based-ink printed layer on the first surface of the base material and a second printed base layer which is a water-based-ink printed layer on the first printed base layer. The first printed base layer is in contact with the second printed base layer, and an area of the second printed base layer is larger than an area of the first printed base layer in a plan view from the first surface side or the second surface side of the base material.

### TECHNICAL FIELD

The present disclosure relates to a label and a label manufacturing method.

### BACKGROUND ART

In recent years, plastic containers such as polyethylene terephthalate bottles (e.g., PET bottles) have been used for various products. It is also common that a plastic label including a printing layer for displaying product information or the like is attached to the body of a plastic container.

For example, Patent Document 1 discloses a container label including an indication on an original film and removably attached and wrapped around a body of a container, the container label including a first printed base layer covering a first indication recognizable from an outer surface side and a background of the first indication; and a second printed base layer covering a second indication recognizable from an inner surface side and a background of the second indication on the original film, wherein the first printed base layer and the second printed base layer are white ink layers having a thickness of 2 to 6 μm, the first indication, the first printed base layer, the second printed base layer, and the second indication are layered in this order on the inner surface side of the original film from a side close to the original film, the first printed base layer is provided to cover the first indication, the second printed base layer is provided on a part but not all of a surface of the first printed base layer, and the second indication is provided on the second printed base layer (claim 1 of Patent Document 1).

### CITATION LIST

### Patent Literature

Patent Document 1: JP 4802387 B

### SUMMARY OF INVENTION

### Technical Problem

To date, as a plastic label, an oil-based ink has been applied onto the surface of a plastic film to form an ink layer. However, with increased environmental awareness in recent years and from a view point of suppressing generation of VOC (volatile organic compound), the formation of an ink layer by printing that involves performing flexographic printing with a water-based ink using a water-based solvent instead of an oil-based ink using an organic solvent has been considered.

However, when the second printed base layer is formed by flexographic printing with a water-based ink on the first printed base layer of the container label described in Patent Document 1, a part of the first printed base layer serving as a base may impair the design of the appearance of the container label, and thus there is a demand for improvement thereof.

### Solution to Problem

According to the embodiment disclosed herein, there can be provided a label including a base material, the base material including a first surface which is one surface of the base material and a second surface which is a surface on an opposite side to the first surface, and the label further including: a first indication which is a water-based-ink printed layer on at least one of the first surface or the second surface of the base material; a first printed base layer which is a water-based-ink printed layer on the first surface of the base material; a second printed base layer which is a water-based-ink printed layer on the first printed base layer; and a second indication which is a water-based-ink printed layer on the second printed base layer, wherein the first printed base layer is in contact with the second printed base layer, and an area of the second printed base layer is larger than an area of the first printed base layer in a plan view from a side corresponding to the first surface or a side corresponding to the second surface of the base material.

According to the embodiment disclosed herein, there can be provided a method for manufacturing a label including a base material, the base material including a first surface which is one surface of the base material and a second surface which is a surface on an opposite side to the first surface, the method including: forming a first indication on at least one of the first surface or the second surface of the base material, the first indication being a water-based-ink printed layer; forming a first printed base layer on the first surface of the base material, the first printed base layer being a water-based-ink printed layer; forming a second printed base layer on the first printed base layer, the second printed base layer being a water-based-ink printed layer; and forming a second indication on the second printed base layer, wherein the forming of the second printed base layer includes printing a water-based ink for forming the second printed base layer on the first printed base layer by flexographic printing in such a manner that the second printed base layer has an area larger than an area of the first printed base layer in a plan view from a side corresponding to the first surface or a side corresponding to the second surface of the base material and the water-based ink is in contact with the first printed base layer, the forming of the second indication includes printing a water-based ink for forming the second indication on the second printed base layer, and the water-based ink for forming the second printed base layer contains a curing agent, and the water-based ink for forming the second indication does not contain a curing agent.

### Advantageous Effects of Invention

According to the embodiment disclosed herein, it is possible to provide a label and a method for manufacturing the label that can reduce the load on the environment and help prevent the design of the appearance of the label from being impaired. According to the embodiment disclosed herein, since the first indication can be visually recognized from the second surface side of the base material and the second indication can be visually recognized from the first surface side of the base material, it is possible to provide a label having a design on both the first surface and second surface of the base material and having an excellent design property and a method for manufacturing the label. According to the embodiment disclosed herein, it is possible to provide a label and a method for manufacturing the label in which the first printed base layer and the second printed base layer are located on the first surface side of the base material, and both the first printed base layer and the second printed base layer exhibit a shielding effect, so that the first indication cannot be visually recognized from the first surface side of the base material and the second indication cannot be visually recognized from the second surface side of the base material.

### BRIEF DESCRIPTION OF DRAWINGS

FIG. 1 is a schematic cross-sectional view of a label according to a first embodiment.

FIG. 2 is a schematic plan view of an example of a relationship between a first printed base layer and a second printed base layer in a plan view from a first surface side of a base material of the label according to the first embodiment.

FIG. 3 is a schematic plan view of an example of a relationship between the first printed base layer and the second printed base layer in a plan view from a second surface side of the base material of the label according to the first embodiment.

FIG. 4 is a schematic cross-sectional view of a label according to a second embodiment.

FIG. 5 is a schematic cross-sectional view of an example of a laminated structure after printing a water-based ink used for forming a second indication on a second printed base layer by flexographic printing in the manufacturing method of the label of the second embodiment.

### DESCRIPTION OF EMBODIMENTS

Hereinafter, embodiments of the present disclosure will be described with reference to the drawings. Note that the same reference numerals denote the same parts or equivalent parts in the drawings used to describe the embodiments.

### First Embodiment

### Label

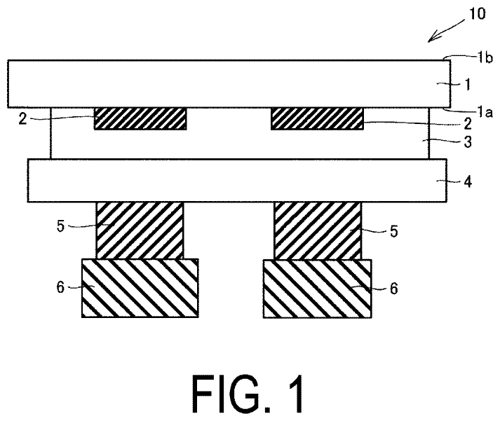

FIG. 1 illustrates a schematic cross-sectional view of a label 10 according to the first embodiment which is an example of a label of the embodiment. The label 10 according to the first embodiment illustrated in FIG. 1 includes a base material 1. The base material 1 includes a first surface 1a, which is one surface of the base material 1, and a second surface 1b, which is a surface on an opposite side to the first surface 1a. The label 10 includes a first indication 2 on the first surface 1a of the base material 1.

The label 10 further includes a first printed base layer 3 which is a water-based-ink printed layer on the first surface 1a of the base material 1, a second printed base layer 4 which is a water-based-ink printed layer on the first printed base layer 3, and a second indication 5 which is a water-based-ink printed layer on the second printed base layer 4. The first printed base layer 3 covers the first indication 2, and the first printed base layer 3 and the second printed base layer 4 are in contact. The label 10 may further include a third printed base layer 6 on the second indication 5.

The label 10 can be used, for example, as a wrap-around label or a shrink label. When the label 10 is used as a wrap-around label, for example, the label 10 can be used by wrapping the label 10 around an article such as a vessel such that the second surface 1b side of the base material 1 is the outer side and the first surface 1a side of the base material 1 is the inner side. When the label 10 is used as a wrap-around label, for example, after an adhesive is applied to each of one end portion and the other end portion of the first surface 1a side of the base material 1, the one end portion is adhered to an article (for example, a body portion of a container body), the label 10 is wound around the article, and the other end portion is superposed on the one end portion and attached. When the label 10 is used as a shrink label, the label 10 is formed into a cylindrical shape such that the second surface 1b side of the base material 1 is the outer side and the first surface 1a side of the base material 1 is the inner side, and one end portion and the other end portion thereof are bonded to each other, and the resulting product is externally fitted to an article and then thermally shrunk.

### Base Material

The base material 1 is a base material containing a resin capable of supporting at least the first indication 2, the first printed base layer 3, the second printed base layer 4, and the second indication 5. The base material 1 may be a transparent (colorless transparent or colored transparent) base material or a base material having appropriate strength and flexibility. However, in the label 10 in which the first printed base layer 3, the second printed base layer 4, and the second indication 5 are provided on the first surface 1a side of the base material 1, the base material 1 is preferably colorless transparent.

When the label 10 is used as a shrink label, for example, a thermoplastic resin film (for example, a resin film that, when formed into a cylinder, thermally shrinks in a circumferential direction of the cylinder) can be used as the base material 1. As the resin contained in the base material 1, examples that can be used include polyester, polypropylene, polystyrene, and polyethylene. The base material 1 may be composed of, for example, a single layer containing one or more types of the resins described above, or may be composed of a plurality of layers having more than one of the single layers stacked.

### First Indication

The first indication 2 can be, for example, a water-based-ink printed layer capable of indicating a pattern, a character, or the like visible when the label 10 is viewed from the second surface 1b side of the base material 1. The first indication 2 can be formed, for example, by printing a water-based ink used for forming the first indication 2 on the base material 1 by relief printing, preferably flexographic printing, and then drying the ink. As the water-based ink used for the formation of the first indication 2, there can be used, for example, a water-based ink that contains a water-based solvent such as water or an alcohol-water solution, a resin, an additive, a pigment, and the like. It is preferable that the water-based ink used for forming the first indication 2 and the first indication 2 formed by using the water-based ink do not contain a curing agent that can be contained in the water-based ink used for forming the first printed base layer 3, the second printed base layer 4, and the third printed base layer 6 described later. Note that the curing agent is a material for making the hardness of a water-based-ink printed layer formed by printing and drying a water-based ink containing a curing agent higher than the hardness of a water-based-ink printed layer formed by printing and drying a water-based ink containing no curing agent.

As the resins contained in the water-based ink, examples that can be used include acrylic resins, urethane resins, polyester resins, polyamide resins, cellulose resins, vinyl chloride resins, vinyl acetate resins, polyolefin resins (for example, polyethylene resins or polybutadiene resins), isocyanate resins, rosin resins, polyvinyl alcohol resins (PVA resins), and imine resins. The first indication 2 may be composed of, for example, a single layer containing one or more types of the resins described above, or may be composed of a plurality of layers having more than one of the single layers layered. As the resin contained in the water-based ink used for the formation of the first indication 2, there can be used, for example, a thermoplastic resin. When the water-based ink contains a curing agent, a resin capable of reacting with the curing agent is preferably used as the resin contained in the water-based ink, and a urethane thermoplastic resin or an acrylic thermoplastic resin is particularly preferably used. The same applies to a water-based ink used for forming the first printed base layer 3, the second printed base layer 4, the second indication 5 and the third printed base layer 6, which will be described later.

As the additive contained in the water-based ink, for example, there can be used a pigment, a plasticizer, an anti-settling agent, a dispersant, a stabilizer, an antifoaming agent, a filler, an antioxidant, an ultraviolet absorber, an antistatic agent, a color separation inhibitor, an emulsifier, a lubricant, or the like.

As the pigment contained in the water-based ink, for example, a coloring pigment of at least one desired color such as red or blue can be used. When the first indication 2 is formed by using a water-based ink containing a coloring pigment of at least one desired color such as red or blue, the first indication 2 can be a water-based color ink layer. For example, when the first indication 2 is composed of a plurality of water-based color ink layers having different colors, it is preferable that at least one of the water-based inks used for forming the first indication 2 does not contain a curing agent, and it is most preferable that all the water-based inks used for forming the first indication 2 do not contain a curing agent.

When the first indication 2 is used as a water-based color ink layer, the water-based ink used to form the first indication 2 may be, for example, a water-based ink in which the content ratio of the water-based solvent is 30% by weight or more of the water-based ink, and the content ratio of the resin other than the water-based solvent, the additive, the coloring pigment, and the like is 70% by weight or less of the water-based ink. Note that the water-based solvent may be 100% water, or may be an aqueous solution containing an alcohol such as ethanol or isopropyl alcohol.

Note that, although a configuration in which the label 10 includes the first indication 2 on the first surface 1a of the base material 1 is described in the present embodiment, the present invention is not limited to this configuration. The label 10 may include the first indication 2 on the second surface 1b of the base material 1, or may include the first indication 2 on both the first surface 1a and the second surface 1b of the base material 1.

### First Printed Base Layer

The first printed base layer 3 can be, for example, a water-based-ink printed layer, preferably containing a curing agent, which can hide the background of the first indication 2 when the label 10 is viewed from the second surface 1b side of the base material 1. The first printed base layer 3 can be formed, for example, by printing a water-based ink used for forming the first printed base layer 3 on the first surface 1a of the base material 1 by relief printing, preferably flexographic printing, and then drying the ink. As the water-based ink used for the formation of the first printed base layer 3, there can be used, for example, a water-based ink that contains a water-based solvent such as water or an alcohol-water solution, a resin, an additive, a pigment, and the like, and preferably a curing agent.

As the curing agent contained in the water-based ink used for the formation of the first printed base layer 3, there can be used a curing agent corresponding to the resin contained in the water-based ink. For example, when a hydroxyl group, a carboxy group, or an amino group is included in the resin contained in the water-based ink, an isocyanate-based curing agent can be used as the curing agent. For example, when a hydroxyl group, an amino group, a carboxy group, or a carbonyl group is included in the resin contained in the water-based ink, an epoxy-based curing agent can be used as the curing agent. For example, when a carboxy group or a carbonyl group is included in the resin contained in the water-based ink, a carbodiimide-based curing agent, an aziridine-based curing agent, an oxazoline-based curing agent, or a hydrazide-based curing agent can be used as the curing agent. When the resin of the water-based ink has a hydroxyl group, for example, an aziridine-based curing agent can be used as the curing agent that can be contained in the water-based ink.

From the viewpoint of concealing the background of the first indication 2 when the label 10 is viewed from the second surface 1b side of the base material 1, the first printed base layer 3 is preferably a water-based white ink printed layer, and more preferably a water-based white ink solid printed layer. The first printed base layer 3 which is a water-based white ink printed layer or a water-based white ink solid printed layer can be formed by, for example, including a white pigment in a water-based ink used for forming the first printed base layer 3, subjecting the water-based ink to relief printing, preferably flexographic printing (particularly solid printing), and then drying the water-based ink. As the white pigment, titanium oxide is preferably used. The content of the white pigment is preferably 30% by weight or more and 85% by weight or less of the total weight of the first printed base layer 3. When the first printed base layer 3 is a water-based white ink printed layer, preferably a water-based white ink solid printed layer, the first printed base layer 3 may contain, for example, a resin, a curing agent, and a white pigment in an amount of 30% by weight or more and 85% by weight or less of the total weight of the first printed base layer 3. Note that the solid printed layer means a layer formed by printing the water-based ink on an area of 90% or more per unit area of a printed region of the water-based ink.

The description of the water-based ink used for forming the first printed base layer 3 other than the above description is the same as that of the water-based ink used for forming the first indication 2, and thus the description thereof is omitted here.

### Second Printed Base Layer

The second printed base layer 4 can be, for example, a water-based-ink printed layer preferably containing a curing agent, which can conceal the background of the second indication 5 when the label 10 is viewed from the first surface 1a side of the base material 1. The second printed base layer 4 can be formed, for example, by printing a water-based ink used for forming the second printed base layer 4 on the first printed base layer 3 by relief printing, preferably flexographic printing, and then drying the ink. As the water-based ink used for the formation of the second printed base layer 4, there can be used, for example, a water-based ink that contains a water-based solvent such as water or an alcohol-water solution, a resin, an additive, a pigment, a curing agent, and the like.

From the viewpoint of concealing the background of the second indication 5 when the label 10 is viewed from the first surface 1a side of the base material 1, the second printed base layer 4 is preferably a water-based white ink printed layer, and more preferably a water-based white ink solid printed layer. The second printed base layer 4 which is a water-based white ink printed layer or a water-based white ink solid printed layer can be formed by, for example, including a white pigment in the water-based ink used for forming the second printed base layer 4, subjecting the water-based ink to relief printing, preferably flexographic printing (particularly solid printing), and then drying the water-based ink.

The description of the water-based ink used to form the second printed base layer 4 other than the above description is the same as that of the water-based ink used to form the first printed base layer 3, and thus the description thereof is omitted here.

### Second Indication

The second indication 5 can be, for example, a water-based-ink printed layer capable of indicating a pattern, a character, or the like visible when the label 10 is viewed from the first surface 1a side of the base material 1. The second indication 5 can be formed, for example, by printing a water-based ink used for forming the second indication 5 on the second printed base layer 4 by relief printing, preferably flexographic printing, and then drying the ink. As the water-based ink used for the formation of the second indication 5, there can be used, for example, a water-based ink that contains a water-based solvent such as water or an alcohol-water solution, a resin, an additive, a pigment, and the like. The water-based ink used to form the second indication 5 of the label 10 of the first embodiment illustrated in FIG. 1 and the second indication 5 formed using the water-based ink preferably do not contain a curing agent that can be contained in the water-based ink used to form the first printed base layer 3, the second printed base layer 4, and the third printed base layer 6. In the label 10 of the first embodiment illustrated in FIG. 1, since the third printed base layer 6 is provided on the second indication 5, the second indication 5 does not contain a curing agent, and thus there is a tendency that the second indication 5 can have an excellent design.

The description of the water-based ink used for forming the second indication 5 other than the above description is the same as that of the water-based ink used for forming the first indication 2, and thus the description thereof is omitted here.

### Third Printed Base Layer

The third printed base layer 6 can be, for example, a water-based-ink printed layer containing a resin, a lubricant, and a curing agent that can protect the second indication 5 from the first surface 1a side of the base material 1. The third printed base layer 6 can be formed, for example, by printing a water-based ink used for forming the third printed base layer 6 on the second indication 5 by relief printing, preferably flexographic printing, and then drying the ink. As the water-based ink used for the formation of the third printed base layer 6, there can be used, for example, a water-based ink that contains a water-based solvent such as water or an alcohol-water solution, a resin, an additive, a pigment, a lubricant, a curing agent, and the like. The lubricant may be, for example, a material that allows the third printed base layer 6 to slide on the outer surface of the container when the label 10 is attached to the container. From the viewpoint of visually recognizing the second indication 5 from the first surface 1a side of the base material 1, the third printed base layer 6 is preferably transparent, and more preferably colorless and transparent.

From the viewpoint of satisfactorily visually recognizing the first indication 2 of the label 10 from the first surface 1a side of the base material 1, the third printed base layer 6 is preferably a water-based transparent ink printed layer, and more preferably a water-based transparent ink solid printed layer. The third printed base layer 6, which is a water-based transparent ink printed layer or a water-based transparent ink solid printed layer, can be formed by, for example, subjecting the water-based ink used for forming the third printed base layer 6 to relief printing, preferably flexographic printing (particularly solid printing), and then drying the water-based ink not containing a coloring pigment.

The description of the water-based ink used to form the third printed base layer 6 other than the above description is the same as that of the water-based ink used to form the first printed base layer 3 and the second printed base layer 4, and thus the description thereof is omitted here.

### Manufacturing Method for Label of First Embodiment

The label 10 of the first embodiment illustrated in FIG. 1 can be manufactured, for example, as follows. First, the first indication 2 is formed on the first surface 1a of the base material 1. The first indication 2 can be formed, for example, by printing a water-based ink used for forming the first indication 2 on the first surface 1a of the base material 1 by relief printing, preferably flexographic printing, and then drying the ink.

Next, the first printed base layer 3 is formed on the first indication 2. The first printed base layer 3 can be formed, for example, by printing a water-based ink used for forming the first printed base layer 3 on the first surface 1a of the base material 1 so as to cover the first indication 2 by relief printing, preferably flexographic printing, and then drying the ink.

Next, the second printed base layer 4 is formed on the first printed base layer 3. The second printed base layer 4 has an area larger than that of the first printed base layer 3 in a plan view from the first surface 1a side of the base material 1, and can be formed by printing a water-based ink for forming the second printed base layer 4 by relief printing, preferably flexographic printing, so as to be in contact with the first printed base layer 3 and then drying the ink.

Next, the second indication 5 is formed on the second printed base layer 4. The second indication 5 can be formed, for example, by printing a water-based ink used for forming the second indication 5 on the second printed base layer 4 by relief printing, preferably flexographic printing, and then drying the ink.

Thereafter, the third printed base layer 6 is formed as the outermost layer of the label 10 on the second indication 5, thereby manufacturing the label 10 of the first embodiment illustrated in FIG. 1.

### Operational Effects of Label of First Embodiment

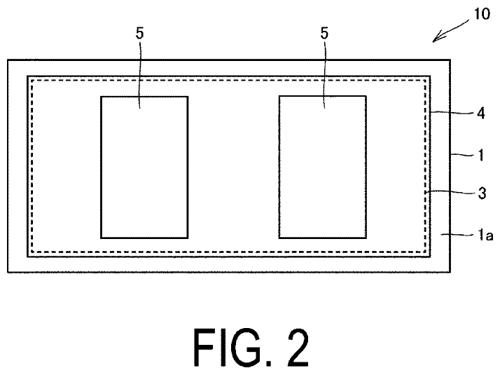

FIG. 2 is a schematic plan view illustrating an example of a relationship between the first printed base layer 3 and the second printed base layer 4 in a plan view from the first surface 1a side of the base material 1 of the label 10 of the first embodiment illustrated in FIG. 1.

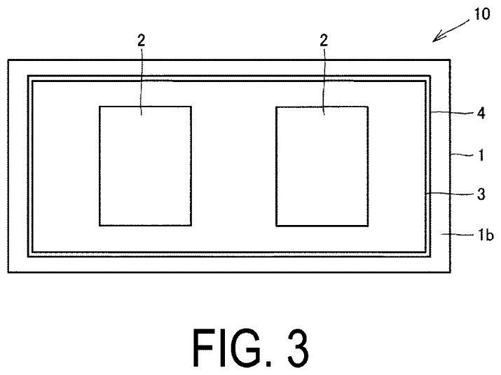

FIG. 3 is a schematic plan view of an example of a relationship between the first printed base layer 3 and the second printed base layer 4 in a plan view from the second surface 1b side of the base material 1 of the label 10 of the first embodiment illustrated in FIG. 1. In the label 10, the first printed base layer 3 and the second printed base layer 4 in contact with each other have a relationship in which the area of the second printed base layer 4 is larger than the area of the first printed base layer 3 in a plan view from the first surface 1a side or the second surface 1b side of the base material 1 as illustrated in FIG. 2 or 3, for example. Since the label 10 has this relationship, it is possible to help prevent the design of the appearance of the label 10 from being impaired.

That is, for example, when the second printed base layer is formed on the first printed base layer of the container label described in Patent Document 1 by printing a water-based ink by relief printing, particularly flexographic printing, the edge of the upper surface of the convex portion of the relief printing, particularly flexographic printing, on which the water-based ink is placed scrapes off a part of the first printed base layer serving as the base, and the design of the appearance of the container label may be impaired.

Therefore, in the label 10 of the first embodiment, as described above, the second printed base layer 4 is formed by printing a water-based ink for forming the second printed base layer 4 on the first printed base layer 3 by relief printing, preferably flexographic printing, such that the second printed base layer 4 has an area larger than that of the first printed base layer 3 in a plan view from the first surface 1a side or the second surface 1b side of the base material 1 and the ink is in contact with the first printed base layer 3, and then drying the ink. Therefore, when the second printed base layer 4 is formed, it is possible to help prevent the edge of the upper surface of the convex portion of the relief printing, preferably flexographic printing, from scraping off a part of the first printed base layer 3. Therefore, it is possible to help prevent the design of the appearance of the label 10 from being impaired. Since the water-based ink is used to form the label 10 of the first embodiment, it is possible to reduce a load on the environment compared with a case where the oil-based ink is used. From the viewpoint of further helping prevent the design of the appearance of the label 10 from being impaired, it is preferable that the outer edge of the second printed base layer 4 not be in contact with the first printed base layer 3.

In a plan view from the first surface 1a side or the second surface 1b side of the base material 1, the first indication 2 and the second indication 5 are preferably provided in a planar region where the first printed base layer 3 and the second printed base layer 4 overlap each other. By providing the first indication 2 in the planar region, it is possible to suppress the occurrence of a phenomenon in which the first indication 2 is visible through the label 10 when viewed from the second surface 1b side of the base material 1. By providing the second indication 5 in the planar region, it is possible to suppress the occurrence of a phenomenon in which the second indication 5 is visible through the label 10 when viewed from the first surface 1a side of the base material 1.

As illustrated in a plan view from the first surface 1a side of the base material 1 in FIG. 2, the second printed base layer 4 preferably covers the entire first printed base layer 3. As illustrated in a plan view from the first surface 1a side of the substrate 1 in FIG. 2, it is preferable that the outer edge of the second printed base layer 4 be located outside the outer edge of the first printed base layer 3, and the outer edge of the second printed base layer 4 and the outer edge of the first printed base layer 3 form an annular area having a given width. As illustrated in a plan view from the first surface 1a side of the base material 1 in FIG. 2, the outer edge of the second printed base layer 4 is preferably located so as to not overlap with the first printed base layer 3. In these cases, when the second printed base layer 4 is formed by relief printing, preferably flexographic printing, so as to be in contact with the first printed base layer 3, it is possible to help prevent the outer edge of the relief plate (flexographic plate) for forming the second printed base layer 4 from being in contact with the first printed base layer 3. Therefore, it is possible to further help prevent the design of the appearance of the label 10 from being impaired.

### Second Embodiment

### Label

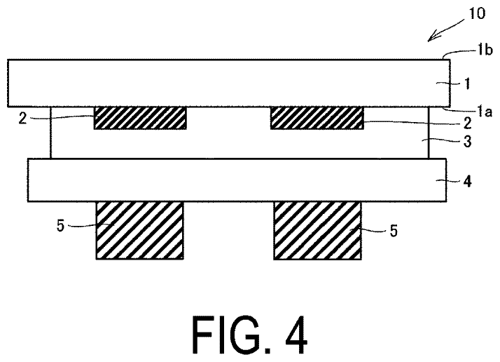

FIG. 4 is a schematic cross-sectional view of the label 10 of a second embodiment, which is another example of the label according to the embodiment. In the label 10 of the second embodiment illustrated in FIG. 4, the second indication 5 on the outermost layer of the label 10 includes a curing agent, while the third printed base layer 6 is not provided on the second indication 5. In the label 10 of the second embodiment illustrated in FIG. 4, it is preferable that the second printed base layer 4 and the second indication 5 be in contact with each other.

### Curing Agent Included in Second Indication

As the curing agent contained in the second indication 5, there can be used a curing agent corresponding to the resin contained in the water-based ink used for forming the second indication 5. For example, when a hydroxyl group or an amino group is included in the resin contained in the water-based ink, an isocyanate-based curing agent can be used as the curing agent. For example, when an amino group or a carbonyl group is included in the resin contained in the water-based ink, an epoxy-based curing agent can be used as the curing agent. For example, when a carbonyl group is included in the resin contained in the water-based ink, a carbodiimide-based curing agent, an aziridine-based curing agent, or a hydrazide-based curing agent can be used as the curing agent.

### Operational Effects of Label of Second Embodiment

Similarly to the label 10 of the first embodiment, in the label 10 of the second embodiment, the first printed base layer 3 and the second printed base layer 4 in contact with each other have a relationship in which the area of the second printed base layer 4 is larger than the area of the first printed base layer 3 in a plan view from the first surface 1a side or the second surface 1b side of the base material 1. Therefore, for the same reason as that of the label 10 of the first embodiment, it is possible to help prevent the design of the appearance of the label 10 from being impaired.

In the label 10 of the second embodiment, compared with the label 10 of the first embodiment, it is possible to suppress the occurrence of blocking (a phenomenon in which, in a label roll on which the label 10 is wound, the water-based ink on the first surface 1a side of the base material 1 of the label 10 is transferred or the like to the base material 1 of another label 10 located immediately above or below the label 10, causing the labels 10 located above and below to stick to each other, making it difficult to unwind the label 10 from the label roll). This is because the present inventors, as a result of intensive studies, have found that the low drying property of the third printed base layer 6 and the printing frequency of the second indication 5 contribute to the occurrence of blocking.

That is, instead of forming the third printed base layer 6 on the second indication 5, the occurrence of blocking can be further suppressed by including a curing agent in the water-based ink used for forming the second indication 5 to increase the hardness of the second indication 5 after drying the water-based ink.

### Lubricant

The water-based ink used for forming the second indication 5 may contain a lubricant to form the second indication 5 containing the lubricant. When the second indication 5 includes a lubricant, it is possible to improve attachability when the label 10 of the second embodiment is attached to a container or the like.

When the second indication 5 does not contain a lubricant, the area of the second indication 5 occupying the surface of the second printed base layer 4 is preferably 50% or less of the area of the surface of second printed base layer 4 in a plan view from the first surface 1a side or the second surface 1b side of the base material 1 as illustrated in FIGS. 2 and 3, for example, from the viewpoint of improving the attachability of the label 10 of the second embodiment on a container or the like.

### Manufacturing Method for Label of Second Embodiment

The label 10 of the second embodiment can be manufactured, for example, as follows. First, the first indication 2 is formed on the first surface 1a of the base material 1. Next, the first printed base layer 3 is formed on the first indication 2. Up to this point, the method is the same as the manufacturing method for the label of the first embodiment.

Next, the second printed base layer 4 is formed on the first printed base layer 3. The second printed base layer 4 can be formed by printing a water-based ink for forming the second printed base layer 4 on the first printed base layer 3 by relief printing, preferably flexographic printing, such that the second printed base layer 4 has an area larger than that of the first printed base layer 3 in a plan view from the first surface 1a side or the second surface 1b side of the base material 1 and the ink is in contact with the first printed base layer 3, and then drying the ink. The water-based ink for forming the second printed base layer 4 contains the curing agent included in the second indication 5 together with the resin.

As the resin contained in the water-based ink for forming the second printed base layer 4, it is preferable to use, for example, a urethane-based thermoplastic resin or an acrylic-based thermoplastic resin having a hydroxyl group, a carboxy group, an amino group, or a carbonyl group. As the curing agent contained in the water-based ink used for forming the second printed base layer 4, there can be used a curing agent corresponding to the resin contained in the water-based ink. For example, when a hydroxyl group, a carboxy group, or an amino group is included in the resin contained in the water-based ink, an isocyanate-based curing agent can be used as the curing agent. For example, when a hydroxyl group, an amino group, a carboxy group, or a carbonyl group is included in the resin contained in the water-based ink, an epoxy-based curing agent can be used as the curing agent. For example, when a carboxy group or a carbonyl group is included in the resin contained in the water-based ink, a carbodiimide-based curing agent, an aziridine-based curing agent, an oxazoline-based curing agent, or a hydrazide-based curing agent can be used as the curing agent. When the resin of the water-based ink has a hydroxyl group, for example, an aziridine-based curing agent can be used as the curing agent that can be contained in the water-based ink.

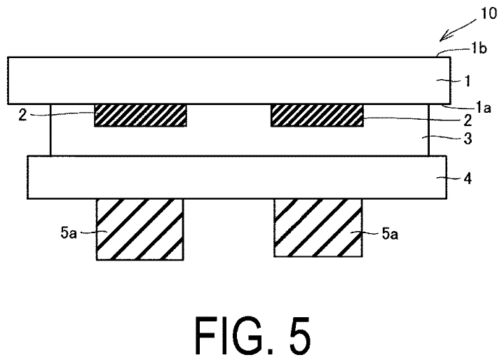

Next, as illustrated in the schematic cross-sectional view of FIG. 5, a water-based ink 5a used for forming the second indication 5 is printed on the second printed base layer 4 by relief printing, preferably flexographic printing. The water-based ink 5a used for forming the second indication 5 does not contain the curing agent contained in the second indication 5, but contains a resin capable of bonding with the curing agent contained in the water-based ink for forming the second printed base layer 4. As the resin of the water-based ink 5a capable of bonding with the curing agent contained in the water-based ink for forming the second printed base layer 4, for example, a urethane-based thermoplastic resin or an acryl-based thermoplastic resin having a hydroxyl group, a carboxy group, an amino group or a carbonyl group is preferably used.

Thereafter, the entire laminated structure after printing of the water-based ink 5a is dried. By diffusing the curing agent in the second printed base layer 4 from the second printed base layer 4 to the second indication 5 before and after the entire laminated structure is dried, the curing agent is made to react with the resin in the water-based ink 5a. As a result, it is possible to manufacture the label 10 of the second embodiment that secures the label physical properties without forming the third printed base layer 6.

In the manufacturing method for the label of the second embodiment described above, the case where the second indication 5 is formed using the water-based ink 5a containing no curing agent has been described. However, the second indication 5 may be formed using a water-based ink 5a containing a curing agent.

Although the embodiments have been described above, an appropriate combination of the configurations of each of the above-described embodiments was also planned from the beginning.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### REFERENCE SIGNS LIST

1 Base material, 1a First surface, 1b Second surface, 2 First indication, 3 First printed base layer, 4 Second printed base layer, 5 Second indication, 5a Water-based ink, 6 Third printed base layer.

1. A label comprising:
a base material, the base material comprising a first surface which is one surface of the base material and a second surface which is a surface on an opposite side of the base material to the first surface;
a first indication which is a water-based-ink printed layer on at least one of the first surface or the second surface of the base material;
a first printed base layer which is a water-based-ink printed layer on the first surface of the base material;
a second printed base layer which is a water-based-ink printed layer on the first printed base layer; and
a second indication which is a water-based-ink printed layer on the second printed base layer,
wherein the first printed base layer is in contact with the second printed base layer, and
an area of the second printed base layer is larger than an area of the first printed base layer in a plan view from a side corresponding to the first surface or a side corresponding to the second surface of the base material.

2. The label according to claim 1, further comprising a third printed base layer which is a water-based-ink printed layer on the second indication,
wherein the third printed base layer includes a curing agent, and
the third printed base layer is transparent.

3. The label according to claim 1, wherein the second indication comprises a curing agent.

4. A method for manufacturing a label comprising a base material,
the base material comprising a first surface which is one surface of the base material and a second surface which is a surface on an opposite side of the base material to the first surface,
the method comprising:
forming a first indication on at least one of the first surface or the second surface of the base material, the first indication being a water-based-ink printed layer;
forming a first printed base layer on the first surface of the base material, the first printed base layer being a water-based-ink printed layer;
forming a second printed base layer on the first printed base layer, the second printed base layer being a water-based-ink printed layer; and
forming a second indication on the second printed base layer,
wherein the forming of the second printed base layer includes printing a water-based ink that forms the second printed base layer on the first printed base layer by flexographic printing in such a manner that the second printed base layer has an area larger than an area of the first printed base layer in a plan view from a side corresponding to the first surface or a side corresponding to the second surface of the base material and the water-based ink is in contact with the first printed base layer,
the forming of the second indication includes printing a water-based ink that forms the second indication on the second printed base layer, and
the water-based ink that forms the second printed base layer contains a curing agent, and the water-based ink that forms the second indication does not contain a curing agent.

5. A label comprising:
a base material, the base material comprising a first surface which is one surface of the base material and a second surface which is a surface on an opposite side of the base material to the first surface;
a first indication which is a water-based-ink printed layer on at least one of the first surface or the second surface of the base material;
a first printed base layer which is a water-based-ink printed layer on the first surface of the base material; and
a second printed base layer which is a water-based-ink printed layer on the first printed base layer;
wherein the first printed base layer is in contact with the second printed base layer,
an area of the second printed base layer is larger than an area of the first printed base layer in a plan view from a side corresponding to the first surface or a side corresponding to the second surface of the base material, and
the first printed base layer and the second printed base layer are water-based white ink printed base layers.
